(19) United States
(12) Patent Application Publication
(10) Pub. No.: US 2009/0224176 A1
(43) Pub. Date: Sep. 10, 2009

(54) A SELF INDICATING MULTI-SENSOR RADIATION DOSIMETER

(76) Inventor: Gordhanbhai N. Patel, Somerset, NJ (US)

Correspondence Address: NEXSEN PRUET, LLC, P.O. BOX 10648, GREENVILLE, SC, 29603, US

(21) Appl. No.: 12/294,148

(22) PCT Filed: Oct. 15, 2007
(86) PCT No.: PCT/US07/81369

§ 371 Date: Sep. 23, 2008

Related U.S. Application Data
(60) Provisional application No. 60/851,948, filed on Oct. 16, 2006.

(51) Int. Cl. G01T 1/02

(52) U.S. Cl. 250/474.1

(57) ABSTRACT

Described is a multi-sensor radiation dosimeter system with (1) a self-indicating, instant radiation sensor and (2) a conventional radiation sensor for monitoring high energy radiations, such as X-ray, electrons and neutrons. Conventional radiation sensors, such as X-ray film, TLD (Thermoluminescence Dosimeters), RLG (Radioluminescence Glass) and OSL (Optically Simulated Luminescence), are highly sensitive but are not instant. In the event of a dirty bomb, nuclear detonation or a radiological accident, one needs to know the exposure instantly so proper precautions can be taken and medical treatment, if required, can be given to the victim. If a self-indicating instant sensor is one of the sensors, one would know the dose instantly, and dose can be determined with higher accuracy than by the traditional methods. This type of device offers the best of both technologies.

### BACKGROUND OF THE INVENTION

This invention relates to a radiation sensitive device for instantly monitoring a dose of high-energy radiation, such as electrons, X-rays, protons, alpha particles and neutrons using a self indicating sensor and accurate dose with a conventional sensor.

Radiation is known to cause cancer. On average, we receive about 0.3 rads/year of high energy radiation. Rad (radiation absorbed dose) is one of the units of radiation exposure. A chest X-ray delivers about 0.03 rads while a CT scan of head and body delivers about 1.1 rads. According to NRC (US Nuclear Regulatory Commission) guidelines, the maximum permitted dose for an occupational radiation worker is 5 rads/year, not to exceed 25 rads for the life. There is no easily detectable clinical effect in human up to 25 rads. However, on average, if 2,500 people are exposed to one rad of radiation, one will die of radiation induced cancer. Hence, we need to minimize the exposure and should monitor radiation exposure from very low dose, e.g., 10 millirads to lethal dose, e.g., 1,000 rads.

Following the detonation of a dirty bomb by terrorists, nuclear bomb or a major accident at nuclear power plant, first responders, medical personnel and the general public need to know, “Did I receive an acceptable low or a lethal dose of ionizing radiation?” Hence, there is a need to know the dose instantly as well with high accuracy. There is also a need for an area dosimeter for the area around radioactive materials, radiation sources, nuclear power plants, nuclear submarine and shipment of radioactive material to monitor radiation dose instantly.

A large number of radiation detectors, monitors and dosimeters are used for detecting and monitoring radiation. The most popular being ionization chambers, proportional counters, Geiger-Mueller counters, scintillation detectors, semiconductor or silicone diode detectors and the like (also referred herein as electronic sensor or electronic dosimeters), and dosimeters such as TLD, OSL, X-ray film and track etch. Track etch type dosimeters are usually used for monitoring high LET (linear energy transfer) particles, such as alpha particles.

X-ray film, TLDs (Thermoluminescence dosimeters), RLG (Radioluminescence glass) and OSL (Optically Simulated Luminescence) are widely used for monitoring personal exposure to X-ray radiation. TLD, TLG and OSL can monitor radiation over a very wide dose range, e.g., 10 millirads -10,000 rads. However, they are not instant and self-reading. They need to be sent to a laboratory for determination of the dose, which may take several days. Small electronic dosimeters are also available commercially.

There are three main types of dosimeter badges of primary use for monitoring high energy radiation. One type contains a silver halide film and is commonly known as a film dosimeter. Another type contains a thermoluminescence material and is commonly known as a TLD dosimeter. Another, more recent, type is an optical simulated dosimeter or OSL which is the acronym for Optically Stimulated Luminescence and RLG, e.g., silver phosphate doped glass which is luminated with a UV laser and light emitted is monitored with a CCD (Charge Coupled Device) camera.

The main advantage of silver halide film is that it has very high final quantum yield and exposure can be essentially permanently stored. However, silver halide film has many disadvantages and drawbacks. Making an emulsion of silver halide is a multi-step and expensive process. Film requires protection from ambient light until fixed and the developing/fixing processes are wet chemical based wherein the concentrations of individual solutions and chemicals, time and temperature of developing and fixing must be strictly controlled. A silver halide badge typically needs to be sent to a processing lab for estimation of radiation dose exposure.

When thermoluminescence (TL) material is radiated electrons are freed from some atoms and moved to other parts of the material leaving behind regions, referred to as holes, of positive charge. Subsequently, when the TL material is heated the electrons and holes recombine releasing the extra energy in the form of light. The light intensity can be measured and related to the amount of energy initially absorbed through exposure to the energy source.

OSL dosimeter/reader technology is relatively new and uses a laser to stimulate an aluminum oxide material. With OSL, a tiny crystal traps stores energy from exposure to ionizing radiation. The amount of exposure can be determined by shining a green light on the crystal and measuring the intensity of the blue light emitted. RLG dosimeter/reader use a UV laser to stimulate a silver phosphate doped glass. With RLG, a tiny glass chip stores energy from exposure to ionizing radiation. The amount of exposure can be determined by shining a UV light, preferably a UV laser, on the crystal and measuring the intensity of the light emitted with photosensor or CCD camera. OSL and RLG systems allow instantaneous readings that can be repeated as opposed to TLD's which take 20 or 30 seconds for a one-time-only reading. The technology offers users increased sensitivity, long term stability, a large energy response range, information on exposure conditions and reanalysis capability.

A holder for film, TLD, RLG and OSL sensors is contained inside a properly designed badge. The badge incorporated a series of filters to determine the quality of the radiation. Radiation of a given energy is attenuated to a different extent by various types of absorbers. Therefore, the same quantity of radiation incident on the badge will produce a different degree under each filter. By comparing these results, the energy of the radiation can be determined and the dose can be calculated by knowing the response for that energy. The badge holder also contains an open window to determine the radiation exposure due to beta particles. Beta particles are effectively shielded by a thin amount of material.

Color changing/developing self-indicating instant radiation alert dosimeters (SIRAD) for monitoring low dose, e.g., 0.1 to 1,000 rads, have been reported recently (U.S. Pat. No. 5,420,000 and PCT applications #WO2004017095 and PCT/US2004005860) and information contained in and references quoted therein are incorporated herein as references.

When exposed to radiation e.g., from a “dirty bomb”, nuclear detonation or a radiation source, the sensing strip of SIRAD develops color, e.g., blue or red color instantly. The color intensifies as the dose increases, thereby providing the wearer and medical personnel instantaneous information on cumulative radiation exposure of the victim. The color intensity of the sensing strip increases with increasing dose. Dose can be estimated with accuracy better than (1) 20% with color reference chart and (2) 10% using a calibration plot of optical density versus dose.

Materials used in the sensing strip of SIRAD are a unique class of compounds called diacetylenes (R—C≡C—C≡C—R, where R is a substituent group). Diacetylenes are colorless solid monomers. They usually form red or blue-colored polymers/plastics, [=(R)C—C≡C—C(R)=]ₙ, when irradiated with high energy radiations, such as X-ray, gamma ray, electrons, and neutrons. As exposure to radiation increases, the color of the sensing strip composed of diacetylenes intensifies proportional to the dose. Using a proper diacetylene and thickness of the coating, one can monitor dose lower than 1 rad, e.g., 0.1 rad or lower. We have now made SIRAD dosimeters able to monitor even lower dose e.g., 0.01 rad by using more sensitive diacetylenes, thicker sensor and scanners and CCD camera type equipment for monitoring color.

A number of patents have been issued on x-ray film, TLD, RLG and OSL type radiation dosimeters. Except U.S. Pat. No. 7,227,158 entitled “A Stick-On Self-indicating Instant Radiation Dosimeter” there is no report on a multi-sensor dosimeter which has one SIRAD type dosimeter and the other conventional type dosimeters such as TLD, OSL, RLG and/or X-ray film type sensors. This type of dosimeter(s) having more than one sensor are described as multi-sensor dosimeter(s), multi-sensor device, SIRAD multi-sensor(s), SIRAD-multi-sensor dosimeter(s) or simply as a device. Self-indicating, color changing or color developing dosimeters and sensors are referred to as self-indicating, color changing or color developing sensor(s), SIRAD sensor(s) or SIRAD dosimeter(s) or simply SIRAD. The methods and instruments used for determination of dose by TLD, OSL, RLG and X-ray film are typically approved, certified or accredited by national or international organizations or businesses, such as National Voluntary Laboratory Accreditation Program (NAVLAP), Department of Energy Laboratory Accreditation Program (DOELAP), National Institute of Standards & Technology (NIST) and equivalent organizations or businesses in the USA. Dose determination by these methods is considered as “Dose of Record”. The Dose of Record can be used in case of dispute or lawsuit. The TLD, OSL, RLG, X-ray, track-etch, electronic type dosimeters or sensors, including doped glass/ceramic and polymeric are individually or collectively referred to as accurate-, precision- or simply as the other-, second- or conventional-dosimeter(s) or sensor(s). The second sensor could be in the form of powder, coating, film, crystal or any other shape. These second sensors and processes associated with them for monitoring dose individually or collectively are also referred to as accurate system(s), precision system(s) or simply as the other system(s), second system(s) or conventional system(s).

A patent entitled “A Stick-On Self-Indicating Instant Radiation Dosimeter” U.S. Pat. No. 7,227,158 by Patel et al. discloses a SIRAD sensor in the form of a label or sticker which is applied on a detector or dosimeter. A drawback of this device is that it is not tamper resistant. Furthermore, a SIRAD sticker can be peeled off. The conventional TLD, OSL, RLG and X-ray film dosimeters are specially designed for occupational radiation workers and hence are expensive and need to be returned, irrespective of whether a SIRAD sticker/label is applied or not. Credit card sized TLD, RLG and OSL dosimeters (a TLD or OSL chip sealed between two plastic films) are less expensive which can be used by non-occupation workers. However, they are not instant and if a SIRAD sticker is applied on them the SIRAD sticker can be tampered and/or peeled off. Hence, there is a need for an improved, composite, one piece, less expensive, tamper resistant, multi sensor dosimeter with at least one of the sensors being a color developing sensor, such as SIRAD to warn the user, usually non-occupational workers, of radiation exposure and the other sensor being the conventional sensor, such as electronic (e.g., semiconductor), TLD, OSL, RLG or X-ray film.

There is also a need for an inexpensive, tamper resistant, area dosimeter for areas around radioactive materials, radiation sources, nuclear power plants, nuclear submarine and shipments of radioactive material to monitor radiation dose instantly and if required accurately. A multi-sensor of the invention would be very convenient to use as an area dosimeter.

Most of the users, including the radiation occupational workers, of radiation dosimeters receive no more than the background dose or negligibly higher than the background dose. However, as they don't see or determine their exposure, they return the dosimeter for determination of the exposure. Hence, there is a need for a disposable dosimeter which can determine whether the user should return the dosimeter for accurate reading. A SIRAD multi-sensor dosimeter will warn its user of radiation exposure just by looking at the SIRAD sensor and if there is no color development at the end of the shelf life or use period, the dosimeter can be disposed off and expenses of reading the accurate dose can be eliminated.

### SUMMARY OF THE INVENTION

It is an object of the present invention to provide a radiation monitoring and detection device which is instant; simple; self-indicating; accurate, tamper resistant, one composite piece and lightweight so it may be carried on a person at all times or applied onto other dosimeters and detectors.

A further object is to provide a radiation monitoring device which is inexpensive; disposable; practically non-destructible; can withstand severe ambient and environmental conditions, such as laundry cycle; tamperproof or tamper evident; does not require external power, such as a battery; integrates the dose for at least one year; is tissue equivalent so that no dose correction is required; retains the dose value and the results/dose can be archived; monitors wide dose range (0.01-1,000,000 rads); monitors all kinds of harmful radiations, such as X-ray, neutrons and high energy electrons over a very wide temperature range (e.g., −20° C. to 60° C.); and is independent of energy and dose rate and if required monitors exposure accurately with a conventional dosimeter.

It is another object of the present invention to provide a dosimeter which can be used in combination with accurate radiation detection devices. This embodiment provides the user a rapid indication of excessive radiation and provides a method for measuring differing forms of radiation or calibration of the second device.

Yet another objective of the present invention is to develop a disposable dosimeter wherein dose can be monitored instantly and then determined accurately if required with conventional sensors and methods.

A particular advantage of the present invention is the simplicity and wide use without the necessity of training for users.

These and other advantages, as will be realized, are provided in a radiation monitoring device with a support; a self-developing, self-indicating, instant radiation sensitive material coated on the support wherein a radiation dose of 0.01 to 1,000,000 rads of ionizing radiation can be monitored visually; and a bonding layer, preferably an adhesive, on the support.

An embodiment of the present invention is provided in a SIRAD multi-sensor radiation dosimeter having at least one self-indicating indicators and at least one accurate sensor.

Another embodiment of the present invention is provided in a SIRAD multi-sensor radiation dosimeter where the self indicating warning and accurate sensors are sandwiched between two layers.

Another embodiment of the present invention is provided in a SIRAD multi-sensor radiation dosimeter where one of the layers is transparent.

Another embodiment of the present invention is provided in a SIRAD multi-sensor radiation dosimeter where one of the layers is opaque.

Another embodiment of the present invention is provided in a SIRAD multi-sensor radiation dosimeter where at least one of the sensor or a portion of the sensor is covered with a removable opaque layer.

Another embodiment of the present invention is provided in a SIRAD multi-sensor radiation dosimeter further comprising an accurate sensor selected from TLD, OSL, RLG, X-ray film and electronic sensor.

Another embodiment of the present invention is provided in a SIRAD multi-sensor radiation dosimeter where the device has a core layer sandwiched between a transparent layer and an opaque layer.

Another embodiment of the present invention is provided in a SIRAD multi-sensor radiation dosimeter comprising a core layer with at least one cavity for the sensors.

Another embodiment of the present invention is provided in a SIRAD multi-sensor radiation dosimeter comprising a cavity with a self indicating and another for accurate sensor therein.

Another embodiment of the present invention is provided in a SIRAD multi-sensor radiation dosimeter wherein the sensors are protected from ambient conditions such as light, humidity and high temperature.

Another embodiment of the present invention is provided in a SIRAD multi-sensor radiation dosimeter wherein the sensors are protected from ambient conditions such as light with a removable or liftable layer.

Another embodiment of the present invention is provided in a SIRAD multi-sensor radiation dosimeter having one or more indicators for monitoring undesirable side effects on either one or both sensors.

Another embodiment of the present invention is provided in a SIRAD multi-sensor radiation dosimeter having an indicator for monitoring false positive.

Another embodiment of the present invention is provided in a SIRAD multi-sensor radiation dosimeter having an indicator for monitoring false negative.

Another embodiment of the present invention is provided in a SIRAD multi-sensor radiation dosimeter having an indicator for monitoring archiving of the exposure.

Another embodiment of the present invention is provided in a SIRAD multi-sensor radiation dosimeter having an indicator for monitoring shelf life.

Another embodiment of the present invention is provided in a SIRAD multi-sensor radiation dosimeter having an indicator for exposure to UV, ambient and sunlight.

Another embodiment of the present invention is provided in a SIRAD multi-sensor radiation dosimeter having more than one indicator selected from: false positive, false negative, temperature, tampering, UV and sunlight exposure and shelf life.

Another embodiment of the present invention is provided in a SIRAD multi-sensor radiation dosimeter having indicators for monitoring false positive, false negative, temperature, tampering, UV and sunlight exposure and shelf life.

Another embodiment of the present invention is provided in a process of removing the accurate sensor of the device by die cutting.

Another embodiment of the present invention is provided in a process of removing the accurate sensor of the device by laser cutting.

Another embodiment of the present invention is provided in a process of determining dose of a removed accurate sensor by a conventional appropriate method including certified, approved and accredited methods.

Another embodiment of the present invention is provided in a SIRAD multi-sensor radiation dosimeter wherein the accurate sensor sandwiched between two non-stick or non-contaminating layers.

Another embodiment of the present invention is provided in a SIRAD multi-sensor radiation dosimeter where an accurate sensor is encapsulated with non-stick or non-contaminating material.

Another embodiment of the present invention is provided in a SIRAD multi-sensor radiation dosimeter comprising a non-stick or non-contaminating layer or material comprising Teflon or silicone.

Another embodiment of the present invention is provided in a process of making of the device comprising lamination.

Another embodiment of the present invention is provided in a process of making the device having at least one cavity by cutting the core layer.

Another embodiment of the present invention is provided in a process of making a cavity by molding the core layer with at least one cavity.

Another embodiment of the present invention is provided in a process of (1) applying a multi-sensor dosimeter on an object including a living individual, (2) exposing the object to radiation, (3) estimating the dose immediately and confirming the same dose by other techniques such TLD, film or electronic and/or archiving the results.

A particular feature of the present invention is the ability to have handling instructions, comparative indicia, and other markings on the device.

These, and other, advantages are provided in a multi-sensor radiation dosimeter having at least one self-indicating sensor and at least one accurate sensor.

Yet another advantage is provided in a process for monitoring radiation including: providing a multi-sensor radiation dosimeter having at least one self-indicating sensor and at least one accurate sensor; exposing the multi-sensor radiation dosimeter to radiation causing at least one measurable signal on the multi-sensor radiation dosimeter wherein the measurable signal is correlated to radiation dose; measuring the measurable signal; and reporting the radiation dose.

Yet another advantage is provided in a process for monitoring radiation including: providing a multi-sensor radiation dosimeter having at least one self-indicating sensor and at least one accurate sensor; exposing the multi-sensor radiation dosimeter to radiation causing at least one measurable signal on the multi-sensor radiation dosimeter wherein the measurable signal is correlated to radiation dose; removing removable or liftable opaque layer for reading the signal, a measuring the measurable signal and reporting the radiation dose.

Yet another advantage is provided in a process for monitoring radiation including: providing a multi-sensor radiation dosimeter having at least one self-indicating sensor and at least one accurate sensor; exposing the multi-sensor radiation dosimeter to radiation causing at least one measurable signal on the multi-sensor radiation dosimeter wherein the measurable signal is correlated to radiation dose; removing at least one sensor from the multi-sensor dosimeter for reading the signal, measuring the measurable signal and reporting the radiation dose.

Another embodiment is provided in a process for detecting radiation. The process includes: attaching a multi-sensor dosimeter comprising at least one self-indicating sensor and at least one an accurate sensor to an object; exposing the multi-sensor dosimeter to radiation; estimating dose immediately by reading the self-indicating sensor; and determining dose by reading the accurate sensor.

A particularly preferred embodiment is provided in a multi-sensor radiation dosimeter having at least one self-indicating sensor and at least one accurate sensor sandwiched between two layers wherein one layer of the two layers is transparent.

### BRIEF DESCRIPTION OF THE DRAWINGS

FIG. 1 is a schematic cross sectional view (not to scale) of a simple form of SIRAD multi-sensor dosimeter.

FIG. 2 is a schematic cross sectional view (not to scale) of a credit card type SIRAD multi-sensor dosimeter with an accurate sensor on one side in the same cavity.

FIG. 3 is illustrates printing on the bottom surface of a credit card type SIRAD multi-sensor dosimeter of FIG. 2.

FIG. 4 illustrates printing on the top surface of a credit card type SIRAD multi-sensor dosimeter of FIG. 2.

FIG. 5 illustrates printing on the top surface of the protective cover of a credit card type SIRAD multi-sensor dosimeter of FIG. 2.

FIG. 6 is a schematic cross sectional view (not to scale) of a sticker type SIRAD multi-sensor dosimeter with an accurate sensor under a SIRAD sensor.

FIG. 7 is a schematic presentation of a top surface of a sticker type SIRAD multi-sensor dosimeter of FIG. 6.

FIG. 8 is a schematic cross sectional view (not to scale) of a sticker type SIRAD multi-sensor dosimeter with an accurate sensor on one side of a SIRAD sensor with each having its own cavity.

FIG. 9 is a schematic presentation of opened multi-sensor dosimeter with three on accurate sensors and SIRAD sensor with appropriate filters.

FIG. 10 is a drawing of a SIRAD multi-sensor dosimeter with SIRAD and TLD sensors in a single long cavity prepared using the general procedure described in Example 2 but before applying the FIT™ indicator and before laminating with the top clear polyester film.

FIG. 11 is a drawing of a SIRAD multi-sensor dosimeter with a TLD sensor using the general procedure described in Example 2 with an opaque FIT™ indicator for monitoring false positive, false negative, tampering, exposure to UV/sunlight, shelf life and archiving protecting the TLD sensor and laminated with a top clear polyester film but without the black protective cover.

### DESCRIPTION OF THE INVENTION

The present invention is directed to a SIRAD multi-sensor dosimeter with at least one dosimeter being self indicating and the other being a conventional, accurate sensor.

SIRAD is a user-friendly, low-cost, wearable, and disposable radiation dosimeter for monitoring high doses (e.g., 0.01-1,000 rads) of ionizing radiations (G. Riel, P. Winters, P. Patel and G. Patel, 14^{th} International Conference on Solid State Dosimetry, Jun. 27-Jul. 1, 2004 and PCT/US2004005860). SIRAD is a self-indicating and instant radiation dosimeter. It is always active and ready to use. It does not need a battery. 90-95% of the color development in a typical diacetylene based SIRAD sensor occurs almost instantly (meaning less than a second after exposure) with the remainder of the color development occurring within minutes to a few hours. As the most of the color development occurs in less than a minute the process is referred to as instant.

The dose range of SIRAD sensor can be extended to a million rads by selecting the proper diacetylenes. Similarly, high dose can be monitored with accurate sensor by selecting the proper sensor and filters.

When exposed to radiation e.g., from a “dirty bomb”, nuclear detonation or a radiation source, the sensing strip of SIRAD develops color, e.g., blue or red color instantly. The color intensifies as the dose increases, thereby providing the wearer and medical personnel instantaneous information on cumulative radiation exposure of the victim. The color intensity of the sensing strip increases with increasing dose. Dose can be estimated with accuracy better than (1) 80% with color reference chart and (2) 90% using a calibration plot of optical density versus dose. The SIRAD accuracy is no better than 95% using optical techniques. The accuracy for a TLD, OSL, RLG and X-ray film dosimeter is usually better than 95% and hence they are referred to as accurate dosimeters. Accuracy is defined herein as the precision with which a number can be expressed as a percentage of the measurement. The visual lower limit of detection of a SIRAD sensor is typically higher than 0.1 rad even though lower dose can be monitored with a densitometer or CCD camera type reader. The accurate dosimeters such as TLD, RLG and OSL are not visual and hence have no visual lower limit of detection. However, with instruments the dose can be determined with accuracy better than 95%.

As mentioned earlier, the materials used in the sensing strip of SIRAD are a unique class of compounds called diacetylenes (R—C≡C—C≡C—R, where R is a substituent group). The sensing strip is sensitive to all forms of radiation with energy greater than that of UV light, and that can also penetrate the protective plastic films that cover the sensing strip. Diacetylenes respond to neutrons, X-ray (energy higher than 10 KeV) and high energy electrons/beta particles. Color development of the sensing strip is essentially independent of dose rate. SIRAD is tissue equivalent and hence no dose correction is required. Particles, such as low energy electrons, protons, alphas, mesons, pions and heavy ions, will be absorbed by the protective films' and will not reach the sensing strip. For the purposes of the present invention reading dose, monitoring dose, determining dose, estimating dose and similar terms refers to any method of measuring a change in a material resulting from exposure to radiation wherein the change is proportional to radiation.

Commercially available radiation dosimeters and accurate detectors such as TLD, OSL, RLG and electronic have many drawbacks as mentioned herein, for example, either it takes days to know the dose, needs power or an instrument to read them. Instead of using SIRAD or conventional radiation monitoring system alone, a better alternative is to use both SIRAD and conventional radiation monitoring system in one piece. SIRAD would monitor high dose (e.g., 0.1 to 1,000,000 rads) with reasonable accuracy while the conventional sensor will monitor the lower dose with a higher accuracy such as better than 95% and more preferably better than 99%, indicating that the measurement can be expressed with less than 5% error. As described in commonly assigned PCT applications WO2004017095 and PCT/US2004005860, SIRAD monitors an accidental high dose (higher than 0.1 rad) instantly, visually, and/or for monitoring annual and lifetime dose. It is also very useful as a co-sensor.

The invention will be described with particular emphasis on the preferred embodiments and will be described with reference to the figures forming an integral part of the specification. In the figures similar elements will be numbered accordingly.

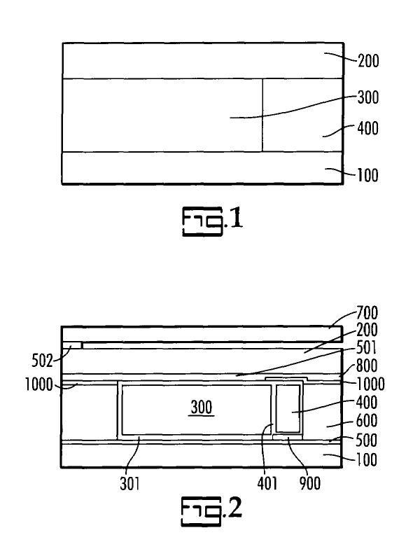

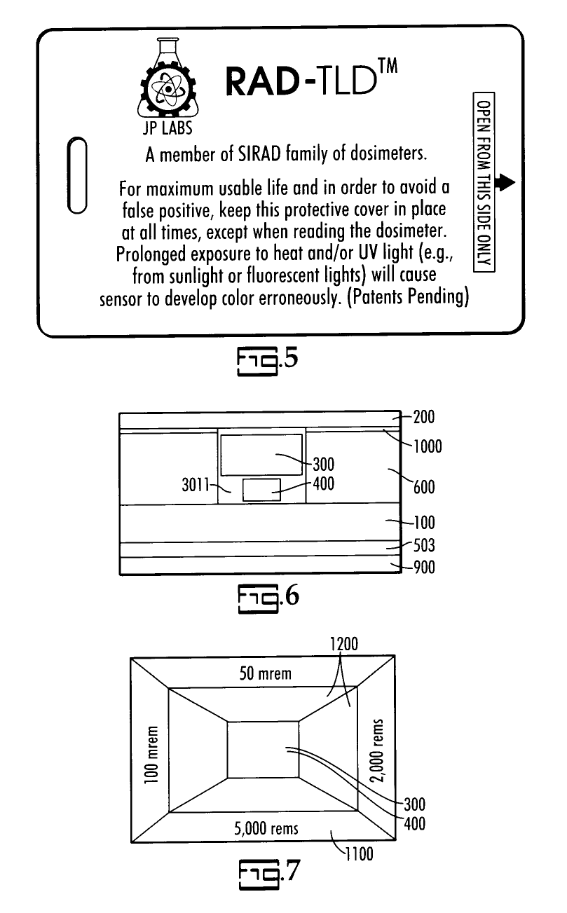

An embodiment of the present invention is illustrated in FIGS. 1-9 and exemplified in FIGS. 10 and 11. In FIG. 1, a SIRAD sensor, 300, and an accurate sensor, 400, are sandwiched between two layers, a top layer, 200, and a bottom layer, 100. In order to see the color of the SIRAD sensor, 300, the top layer, 200, should be transparent. The bottom layer could be opaque. The device can be sealed (not shown in FIG. 1) at the edges. If the accurate sensor is light sensitive it alone can have an extra opaque layer to protect it from light or the whole device can be protected by a liftable opaque layer, 700, as shown in FIG. 2, placed in an opaque envelope or container.

For the purposes of the present invention opaque refers to a material which transmits less than 10% of visible light passing there through and transparent refers to a material which absorbs less than 10% of visible light passing there through.

Yet another embodiment of the SIRAD multi-sensor dosimeter is to sandwich an accurate sensor between two SIRAD sensors, which are usually in the form of a thin film, or between a SIRAD sensor and an opaque substrate.

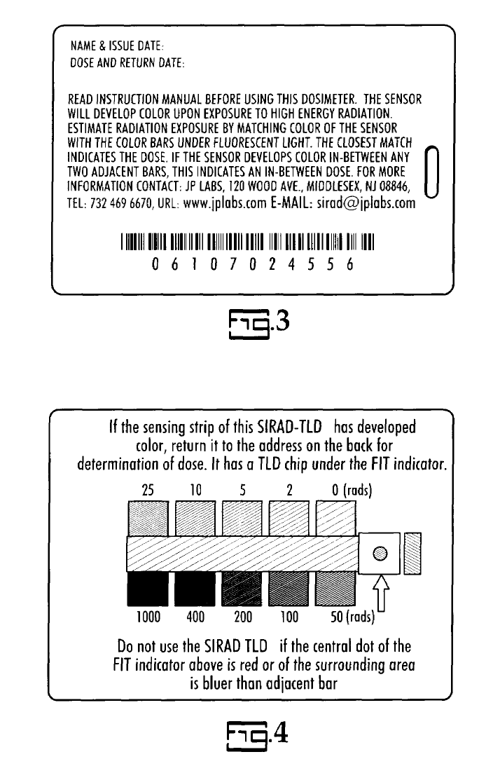

The SIRAD multi-sensor could be in a more practical usable form such as a credit card as shown schematically in FIG. 2 or a sticker as shown schematically in FIGS. 6 and 8. A credit card device will be described with reference to FIG. 2. In a credit card type device, a core layer, 600, pre-printed with color reference bars and instructions, 1000, having cavities, 301 and 401, for SIRAD and accurate sensors respectively, is bonded to a bottom layer, 100, with a bonding layer, 500. A SIRAD sensor, 300, and accurate sensor, 400, are placed in their respective cavities and bonded with a transparent layer, 200, with a bonding layer, 501. If protection from visible and UV light is required, an opaque protective layer, 700, can be applied with a narrow bonding layer, 502. If the accurate sensor is sensitive to visible or UV light it can be protected with an opaque layer, 800, and if it is affected or contaminated by the bonding layers, 500 or 501, it can be protected with a non-bonding and/or non-contaminating layers, 900 and 800. The surfaces of layers 100, 600, 200 and 700 could have additional printing, e.g., color reference bars for estimation of dose exposure, instruction and information, as shown in FIGS. 3, 4 and 5 respectively. The device could have one or more indicators for false positive, negative, temperature, shelf life, exposure to UV Light and/or tamper indicators which can be applied on an opaque layer, 1000, or anywhere on the dosimeter. The accurate sensor can also be placed underneath the SIRAD sensor.

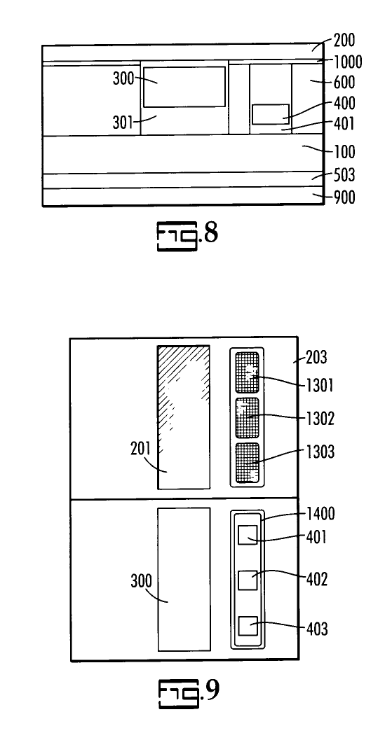

The device can also be any other shape, for example a sticker or label as shown schematically in FIGS. 6, 7 and 8. In this sticker type device of FIGS. 6 and 8, a core layer, 600, pre-printed with instructions, 1000 (shown schematically in FIG. 7 as top view), having cavities, 301 and 401, for SIRAD and accurate sensors respectively or a common cavity 3011, is bonded to a bottom layer, 100. In order to apply the device on an object including a living individual, the device could have an adhesive layer, 503 and release layer 900. A SIRAD sensor, 300, and an accurate sensor, 400, are placed in a common cavity, 3011, (FIG. 6) or in their respective cavities, 301 and 401, (FIG. 8) and bonded with a transparent layer, 200. If protection from visible and UV light is required, an opaque protective layer similar to FIG. 2 can be applied. The surfaces of layers 100, 600 and 200 could have additional printing, e.g., color reference bars for estimation of dose exposure as shown schematically in FIG. 7. The device could have one or more indicators for false positive, negative, temperature, UV exposure and/or tamper indicator (not shown). The accurate sensor, 400, can be placed anywhere in the core layer, for example underneath the SIRAD sensor as shown in FIG. 6 or on one side as shown in FIG. 8. The core layer, 600, or transparent layer, 200, could have color reference bars, 1200, and, for example, other instructions, 1100, printed on them as shown in FIG. 7.

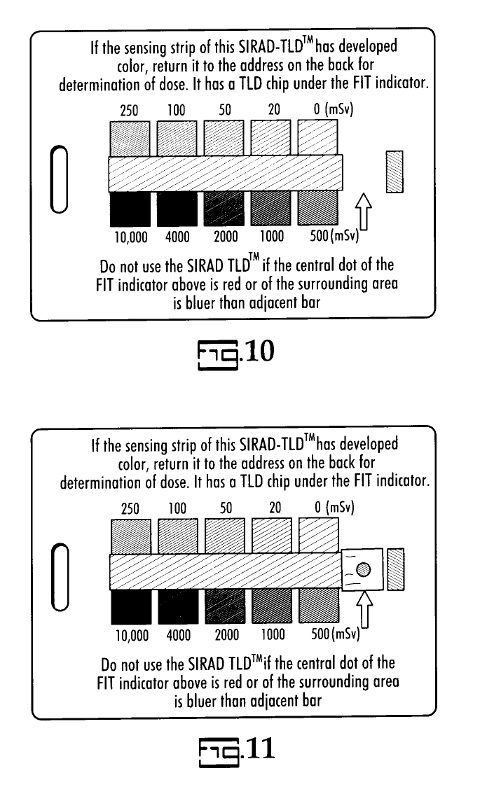

In order to selectively filter certain types of radiation, such as low energy electrons or low energy X-ray, both the SIRAD sensor, 300, and the accurate sensor, 400, can have additional filters. Such filters 1301, 1302 and 1303, for accurate sensors 403, 402 and 401, respectively, are shown in a foldable form of the device as shown in FIG. 9. Similarly, SIRAD sensor can also have filters similar to 1301, 1302 and 1303 (not shown). The SIRAD and accurate sensors can be encapsulated in a bag or between layers to prevent contamination or to protect from light, for example with a protective bag, 1400, as shown in FIG. 9. The top cover, 203, of the foldable device of FIG. 9 could have a window, 201, for seeing color of the SIRAD sensor, 300, when the device is closed or assembled. These accurate sensors could also be in a holder and the badge (outer case for the holder) could be similar to those of Global Dosimetry, Landauer and Panasonic for TLD, OSL and X-ray film. The badge having a self indicating sensor allows users to know their exposure immediately and accurate dose can be determined by proper accredited methods. All these multi-sensor dosimeters of FIGS. 1, 2, 6, 8 and 9 offer the best of both technologies.

The device could be in the form of a tiny dot to very large, e.g., several square feet.

By selecting proper materials, these dosimeters can be designed to monitor dose higher than 1,000 rads such as 1 megarad.

A preferred class of radiation sensitive materials that can be used for making the shaped-articles are diacetylenes having general formula, R′—C≡C—C≡C—R″, where R′ and R″ are the same or different substituent groups. Though this class of diacetylenes is preferred, other diacetylenes having the following general formulas can also be used: higher acetylenes: R′-(C≡C)ₙ—R″, where n=3-5; split di and higher acetylenes: R′-(C≡C)ₘ-Z-(C≡C)ₒ—R″, where Z is any diradical, such as —(CH₂)ₙ— and —C₆H₄—, and m and o is 2 or higher; and polymeric di and higher acetylenes: [-A-(C≡C)ₙ—B-]ₓ, where A and B can be the same or different diradical, such as —(CH₂)_{b}—, —OCONH—(CH₂)_{b}—NHCOO—, and —OCO(CH₂)_{b}OCO—. where R′ and R″ can be the same or different groups.

The preferred diacetylenes include those where R′ and R″ are selected from: (CH₂)_{b}—H; (CH₂)_{b}OH; (CH₂)_{b}—OCONH—R1; (CH₂)_{b}—O—CO—R1; (CH₂)_{b}—O—R1; (CH₂)_{b}—COOH; (CH₂)_{b}—COOM; (CH₂)_{b}—NH₂; (CH₂)_{b}—NHCOR1; (CH₂)_{b}—CONHR1; (CH₂)_{b}—CO—O—R1; where b=1-10, preferably 1-4, and R1 is an aliphatic or aromatic radical, e.g. C₄-C₆ alkyl or phenyl or substituted phenyl, and M is a cation, such as Na⁺ or (R1)₃N⁺.

The preferred diacetylenes are the derivatives of 2,4-hexadiyne, 2,4-hexadiyn-1,6-diol, 3,5-octadiyn-1,8-diol, 4,6-decadiyn-1,10-diol, 5,7-dodecadiyn-1,12-diol and diacetylenic fatty acids, such as tricosa-10,12-diynoic acid (TC), pentacosa-10,12-diynoic acid (PC), their esters, organic and inorganic salts and cocrystallized mixtures thereof. The most preferred derivatives of the diacetylenes, e.g. 2,4-hexadiyn-1,6-diol, are the urethane and ester derivatives.

Preferred urethane derivatives are alkyl, aryl, benzyl, methoxy phenyl, alkyl acetoacetate, fluoro phenyl, alkyl phenyl, halo-phenyl, cyclohexyl, toyl and ethoxy phenyl of 2,4-hexadiyn-1,6-diol, 3,5-octadiyn-1,8-diol, 4,6-decadiyn-1,10-diol, 5,7-dodecadiyn-1,12-diol. The prefer urethane derivatives are methyl, ethyl, propyl and butyl derivatives of 2,4-hexadiyn-1,6-diol, 3,5-octadiyn-1,8-diol, 4,6-decadiyn-1,10-diol, 5,7-dodecadiyn-1,12-diol.

The following are some of the preferred derivatives of 2,4-hexadiyn-1,6-diol: urethane (—OCONH—) derivatives, R′CH₂—C≡C—C≡C—CH₂R′, including: hexyl urethane: 166, R′═OCONH(CH₂)₅ CH₃; pentyl urethane: 155, R′═OCONH(CH₂)₄CH₃; butyl urethane: 144, R′═OCONH(CH₂)₃ CH₃; ethyl urethane: 122, R′═OCONHCH₂CH₃; methyl urethane: 111, R′═OCONHCH₃; ester (—OCO—) derivatives, R′″CH₂—C≡C—C≡C—CH₂R′″, including: butyl ester: 144E, R′″═OCO(CH₂)₃CH₃; ethyl ester: 122E, R′″═OCOCH₂CH₃; methyl ester: 111E, R′″═OCOCH₃; symmetrical diacetylenes including: 156: R′—C≡C—C≡C—R″, where R′═CH₂OCONH(CH₂)₅CH₃ and R″═CH₂OCONH(CH₂)₄—CH₃; cocrystallized mixtures including: containing 80 weight percent or above of 166; 85:15 mixture of 166 and 156; 90:10 mixture of 166 and 156 and 4:1 mixture of tricosadiynoic acid and pentacosadiynoic acid(TP41).

The further preferred diacetylenes are derivatives of 3,5-octadiyn-1,8-urethane, 4,6-decadiyn-1,10-urethane and 5,7-dodecadiyn-1,12-urethane, e.g., hexyl urethane: R′═OCONH(CH₂)₅ CH₃; pentyl urethane: R′═OCONH(CH₂)₄ CH₃; butyl urethane: R′═OCONH(CH₂)₃ CH₃; propyl urethane: R′═OCONH(CH₂)₂ CH₃; ethyl urethane: R′═OCONHCH₂CH₃; methyl urethane: R′═OCONHCH₃.

The most preferred diacetylenes are the urethane derivatives such methyl, ethyl, propyl and butyl urethane derivatives of 4,6-decadiyn-1,10-diol, e.g., diacetylene 344 [R′—C≡C—C≡C—R′ where R′═OCONH(CH₂)₃CH₃. Though individual diacetylenes can be used, it is desirable to alter the reactivity of diacetylenes by cocrystallization. Cocrystallization can be achieved by dissolving two or more diacetylenes, preferably conjugated, prior to molding. For example, when TC and PC are co-crystallized, the resulting cocrystallized diacetylene mixture, such as TP41 (4:1 mixture of TC:PC) has a lower melting point and significantly higher radiation reactivity. The reactivity can also be varied by partial neutralization of diacetylenes having —COOH and —NH₂ functionalities by adding a base, such as an amine, NaOH, Ca(OH)₂, Mg(OH)₂ or an acid, such as a carboxylic acid, respectively.

Other preferred diacetylenes are amides of fatty chain acid, such as TC and PC. The preferred amides are: TCAP═CH₃(CH₂)₉—C≡C—C≡C—(CH₂)₈—CONH—(CH₂)₃CH₃; PCAE=CH₃(CH₂)₁₁—C≡C—C≡C—(CH₂)₈—CONH—CH₂CH₃; PCAP═CH₃(CH₂)₁₁—C≡C—C≡C—(CH₂)₈—CONH—(CH₂)₃CH₃; PCACH═CH₃(CH₂)₁₁—C≡C—C≡C—(CH₂)₈—CONH—C₆H₅; and TCACH═CH₃(CH₂)₉—C≡C—C≡C—(CH₂)₈—CONH—C₆H₅.

In order to maximize radiation reactivity, 166 can be co-crystallized with other diacetylenes, e.g. 155, 157, 154 and 156, which are described above. Though certain diacetylenes, such as 155, increase the reactivity of 166, the partially polymerized cocrystallized diacetylenes provide a red color upon melting. However, 156 increases the radiation reactivity of 166 and provides a blue color upon melting the partially polymerized diacetylene mixture. 166 can be cocrystallized with different amounts of 156. Preferred is where the amount is 5-40 weight percent of 156 to 166, most preferred are 90:10 and 85:15 respective weight ratios of 166:156. As used herein “9010” and “8515” refer to these specific cocrystallized mixtures.

Other asymmetrical derivatives, including different functionalities, e.g., ester as one substituent and urethane as the other, can also be prepared. A procedure for synthesis of a 90:10 mixture of 166 and 16 PA is given in U.S. Pat. No. 5,420,000. Using the general procedures given in U.S. Pat. No. 5,420,000, it is possible to prepare a variety of other asymmetrical derivatives and their mixtures for cocrystallization.

Polymers having diacetylene functionality [e.g., {—R′-(C≡C)ₙ—R″-}ₓ, where R′ and R″ can be the same or different diradical, such as —(CH₂)ₙ—, —OCONH—(CH₂)ₙ—NHCOO— and —OCO(CH₂)ₙOCO— in their backbones are also preferred because of the fact that they are polymeric and do not require a binder.

The preferred diacetylenes are those which have a melting point between 60-150° C. and which crystallize rapidly when cooled at a lower temperature, e.g. room temperature.

Another class of preferred diacetylenic compounds is those having an incorporated metal atom and they can be used as built-in converters. Diacetylenes having functionalities, such as amines, ethers, urethanes and the like can form complexes with inorganic compounds. It is possible to synthesize diacetylenes having an internal converter, which is covalently bonded, such as boron and mercury, lithium, copper, cadmium, and other metal ions. For example, the —COOH functionality of TC, PC and TP41 can be neutralized with lithium ion and synthesis of R—C≡C—C≡C—Hg—C≡C—C≡C—R is reported (M. Steinbach and G. Wegner, Makromol. Chem., 178, 1671 (1977)). The metal atom, such as mercury atom thereby incorporated into the diacetylene can emit short wavelength irradiation upon irradiation with photons and electrons.

Though diacetylenes are the most preferred radiation sensitive materials, other radiation sensitive materials can also be used for making the devices using the procedure and formulations described here. The radiation sensitive materials/formulations described in Imaging Systems, K. I. Jacobson and P. E. Jacobson, John Wiley and Sons, NY 1976 can also be used to make radiation sensitive shaped-articles. In addition to silver halides, e.g., AgCl, AgBr, Agl, silver molybdate, silver titanate, silver mercaptide, silver benzoate, silver oxalate, and mixtures thereof; salts and organic, inorganic and organometallic complexes of metals, such as iron, copper, nickel, chromium and transition metals, e.g., mercury oxalate, iron oxalate, iron chloride, potassium dichromate, copper chloride, copper acetate, thallium halides, lead iodide, lithium niobate, and mixtures thereof; aromatic diazo compounds, polycondensates of diazonium salts, the naphthoquinone diazides, photopolymers and photoconductive materials, are also preferred radiation sensitive compositions for making the devices.

The other major class of radiation sensitive materials that can be used in the pre-shaped radiation sensitive device of the present invention are radiochromic dyes, such as new fuschin cyanide, hexahydroxy ethyl violet cyanide and pararose aniline cyanide, leuco crystal violet, leuco malachite green and carbinol dyes, such as malachite green base and p-roseaniline base and those described in U.S. Pat. Nos. 2,877,169; 3,079,955; and 4,377,751.

These radiochromic dyes and other dyes which change color with change in pH, e.g., with acids can be used in combination with materials which produce acid upon irradiation, e.g., organic halocompounds, such as trichloroethane, ethyltrichloroacetate, chlorinated paraffins and chlorinated polymers. The acid produced can react with the pH sensitive dye and change color. Certain iodinium salts, such as, diphenyliodonium hexafluoroarsenate, and diphenyliodonium chloride produce protonic acids, such as, HCl, HF, HBF₄ and HASF₆ upon irradiation with high energy radiation (J. Crivello, Chemtech, October 1980, page 624; “The Chemistry of Halides, Pseudohalides, and Azides”, S. Patai (Ed.), John Wiley, New York, 1983). Iodinium and sulfonium compounds can be mixed with some pH dyes including the radiochromic dyes. The sulfonium, iodinium and alike compounds, in which the primary photochemical reaction produces a super acid and this super acid is employed catalytically to generate other acids. Thus the color development is amplified. Such systems, have been described in U.S. Pat. No. 6,242,154 and references cited therein.

The top layer, 200, core layer, 600, and bottom layer, 100, of the SIRAD multi-sensor devices could be any material such a plastic, paper and metal. The preferred material is a plastic. They could be made from natural and synthetic polymers, such as polyolefins, polyvinyls, polycarbonate, polyester, polyamide, or copolymer and block copolymers such as ABS (copolymer of acrylonitrile, butadiene and styrene) and cellulose acetate. The most preferred materials for these layers are polyesters, polycarbonates, polyolefins, polyvinyls and copolymers such as ABS. These layers could be made from the same or different plastics. The most preferred materials are films of polyethylene terephthalate (PET), polyvinylchloride (PVC), and polycarbonate.

The preferred thickness for a transparent top layer, 200, and bottom opaque layer, 100, is between 50-1,000 microns. The most preferred thickness is 100-250 microns.

The top transparent layer, 200, can be PET, PETG (glycolated PET) or PVC (polyvinylchloride). Preferred is PET. The top surface is preferably treated physically or chemically for antiglare and scratch resistance. It is preferred that the scratch resistance be at least equivalent to the scratch resistance of PET film. It is most preferable to include UV absorbance. UV absorbing PET film is commercially available. The thickness is preferably 125-250 microns (0.005-0.0110 inch).

The middle core layer, 600, could be a plastic film, such as PVC, PET or polyolefin (e.g., Teslin^{R} or Artisyn^{R}) with die-cut cavities for sensors. The core layers should preferably be opaque. The core layer is printed with any conventional method of printing. The thickness of the core layer could be from 50 to 1,000 microns. It is preferable that the minimum thickness is that of the sensors.

A preferred core material, 600, is commercially available polyolefin membrane layer called Teslin^{R} or Artisyn^{R}. However, any other core material, e.g., polyester, PETG and PVC which can provide good bonding with the top and bottom layers, can be used.

The bottom material, 100, can be PET, PETG, PVC Teslin^{R} or Artisyn^{R}. The bottom surface is preferably writable with an average ball point pen. It is highly preferred that each card have a different serial number and corresponding bar code printed on the bottom layer. The bottom material is preferably white and highly opaque. It could also be a metal foil or a metallized plastic film. The preferred thickness is 125-250 microns (0.005-0.0110 inch).

The adhesive layers, 500, 501, 502 and 503, could be a pressure sensitive adhesive or a low melt adhesive. Other industrial and common adhesives, including two component adhesives such as those of polyepoxy and polyurethane can also be used for making adhesive layers, 500, 501, 502 and 503. For heat activated adhesives it is particularly preferred that the adhesive have a melting point of less than 100° C. In order to make the cards tamper resistant, the preferable bonding layer is heat activated adhesive or two component bonding materials, such as polyepoxy or polyurethane or those that can be cured by crosslinking. Heat activated adhesive is preferred as it makes the device tamper resistant and provides a stronger bond than that provided by a pressure sensitive adhesive.

A large number of radiation detectors, monitors and dosimeters are used for detecting and monitoring radiation. The most popular being ionization chambers, proportional counters, Geiger-Mueller counters, scintillation detectors, semiconductor diode detectors (also referred herein as electronic sensor or electronic dosimeters), and dosimeters such as TLD, OSL, X-ray film and track etch. Track etch type dosimeters are usually used for monitoring high LET (linear energy transfer) particles, such as alpha particles. The preferred accurate sensors are TLD, OSL, X-ray film and semiconductor diode. Thick (˜1 mm) SIRAD sensors with a highly sensitive diacetylene and a lower limit of detection of 0.01 rad can be prepared. This highly sensitive SIRAD can be used instead of the conventional accurate sensors. In one SIRAD multi sensor dosimeter, there could be different types of accurate sensors such as TLD and OSL both in one device.

The materials, designs and processes which can be used for making SIRAD multi-sensor dosimeters are described in the following patent applications and issued patents which are incorporated by references: Patent Application # WO2004017095—“Thick Radiation Sensitive Devices”; Patent Application # WO2004077097—“Personal And Area Self-indicating Instant Radiation Alert Dosimeter”; U.S. Pat. No. 7,227,158 titled “A Stick-on Self-indicating Instant Radiation Dosimeter”; U.S. patent application Ser. No. 11/235,892 filed Sep. 27, 2005 titled “Tamper Resistant Self Indicating Instant Alert Radiation Dosimeter”; U.S. patent application Ser. No. 11/413,505 filed Apr. 28, 2006 titled “A Detector for UV False Positive of Radiation Sensitive Devices”; WIPO Application PCT/US06/39457 filed Oct. 6, 2006 titled “Time-temperature, UV exposure and Temperature indicator”; WIPO Application PCT/US06/39623 filed Feb. 21, 2006 titled “A method of making smart cards with an encapsulant without a bulge”; and U.S. patent application Ser. No. 11/699,520 filed Jan. 29, 2007 titled “A general purpose, high accuracy dosimeter reader”.

The size of the SIRAD multi-sensor dosimeter could vary from 1 square mm to any large size e.g., credit card or 1 meter by 1 meter with more than one accurate sensor.

Though the SIRAD sensor can be read visually, it can also be read accurately with optical sensitometer, spectrophotometer, optical scanner and CCD type camera reader.

### EXAMPLES

The following Examples are illustrative of carrying out the claimed invention but should not be construed as being limitations on the scope and spirit of this invention.

### Example 1

### SIRAD Sensor

A SIRAD sensor was prepared using a diacetylene, shelf-life extenders as described in WO2004017095 and PCT/US2004/005860. In order to protect from UV/sunlight, a UV absorbing topcoat was applied on the diacetylene coat.

### Example 2

### Making of MS-Dosimeter

A SIRAD multi-sensor dosimeter similar to FIG. 2 was formed by die cuffing a 3.5 cm long and 8 mm wide cavity in a 0.889 mm (0.035 inch) thick core layer of Teslin®) (a microporous battery membrane supplied by PPG Industries, Pittsburgh, Pa.). The core layer was pre-printed with color reference bars and other information. A 0.254 mm (0.01 inch) opaque PET (polyethylene terephthalate) film having an adhesive layer was laminated to the core layer to create a cavity for the sensors. This film was pre-printed on the non-adhesive side with instructions. A SIRAD sensor of example 1 and a commercially available TLD sensor were inserted between two nonstick layers. An indicator for monitoring false positive, false negative and shelf indicators (referred as FIT™ indicator in FIG. 4) and described in U.S. patent application Ser. No. 11/413,505 filed Apr. 28, 2006 was applied. A 0.254 mm (0.01 inch) transparent PET film having an adhesive layer and (6) applying a 0.102 mm (0.004 inch) black protective layer having a thin adhesive layer was applied.

Instead of a TLD chip any other sensor such as OSL, RLG, X-ray film, electronic chips and the like can be used.

A photo of a SIRAD multi-sensor dosimeter with SIRAD and TLD sensors in a single long cavity was prepared using the general procedure described in Example 2 but before applying the FIT™ indicator and before laminating with the top clear polyester film is provided in FIG. 10.

A photo of a SIRAD multi-sensor dosimeter with a TLD sensor using the general procedure described in Example 2 with a FIT™ indicator for monitoring false positive, false negative, temperature, UV exposure, tampering, shelf life and archiving protecting the TLD sensor and laminated with a top clear polyester film but without the black protective cover is provided in FIG. 11.

There are many variations and modifications of the above described SIRAD multi-sensor dosimeter. For example, the cavity can be created by molding or casting the core layer. It is desirable but not necessary to use the core layer. It is desirable to use indicators such as false positive, false negative, UV exposure, temperature, archiving and shelf life indicators individually or collectively (e.g., FIT) but they are not required. PET films are particularly suitable top and bottom layers to hold the sensors but it could be any other plastic or other materials such as metal and non-plastic and non-metallic materials. Any type of adhesive, e.g., pressure sensitive, two components or heat activated, melting adhesive can be used for lamination of the device. The sensors could be applied on one surface of a substrate as well. The sensor, especially the accurate sensor can be encapsulated in film or metal foil or can be sandwiched between any two films or coatings which prevent them from being contaminated during manufacturing and use and/or to protect from ambient conditions such as light and humidity. The accurate sensor could have a cavity and holder of its own.

Even though a preferred embodiment utilizes SIRAD as a self-indicating sensor and TLD as an accurate sensor, any other self indicating and accurate sensors such as OSL, RLG, X-ray film, doped ceramic and electronic chips can be used. There could be more than one SIRAD and more than one accurate sensor. These sensors could have filters to filter off selective radiation from visible light to megavolt energy radiation such as electrons and photons.

Though the preferred size and thickness is that of a credit card the dosimeter could be of any reasonable thickness and shape.

### Example 3

### Irradiation of the Device

The SIRAD multi-sensor dosimeters of example 2 were irradiated with different dosages of 100 KeV X-ray. The SIRAD sensor developed color instantly, depending upon the dose.

### Example 4

### Cutting of TLD Sensor Out

The TLD sensor was die-cut out with a special steel ruled die. The TLD chip was removed and sent to an analytical lab for analysis.

One can cut out the accurate sensor with any other technique such as a laser.

The method used for determination of accurate dose will depend upon accurate sensor.

If either sensor has a removable or liftable opaque layer over it, the dose can be ready by removing or lifting the opaque layer and reading the dose visually or with an instrument/reader such as those used for reading OSL and RLG dosimeters, that is by exposing it with a light source, preferably a laser and monitoring emitted or absorbed light with photosensor or CCD camera.

### Example 5

### Application of SIRAD Multi Sensor Dosimeter

The SIRAD multi-sensor dosimeter of Example 2 was used as a dosimeter by individuals and applied to different objects.

The present invention has been described with particular reference to the preferred embodiments without limit thereto. One of skill in the art could envision alternate embodiments and alterations which are not specifically detailed but which are within the literal and equivalent scope of the invention as more specifically set forth in the claims appended hereto.

Claimed is:

1. A multi-sensor radiation dosimeter having at least one self-indicating sensor and at least one accurate sensor.

2. The multi-sensor radiation dosimeter of claim 1 wherein said self indicating sensor and said accurate sensor are sandwiched between two layers.

3. The multi-sensor radiation dosimeter of claim 2 wherein one layer of said two layers is transparent.

4. The multi-sensor radiation dosimeter of claim 2 wherein one layer of said two layers is opaque.

5. The multi-sensor radiation dosimeter of claim 1 further comprising an ambient condition protective layer.

6. The multi-sensor radiation dosimeter of claim 5 wherein said ambient condition is sunlight.

7. The multi-sensor radiation dosimeter of claim 1 wherein said accurate sensor is selected from TLD, OSL, RLG, X-ray film, doped ceramic, plastic and electronic.

8. The multi-sensor radiation dosimeter of claim 1 wherein said self-indicating sensor has an accuracy of at least 80%.

9. The multi-sensor radiation dosimeter of claim 1 wherein said self-indicating has an accuracy which is at least 90%.

10. The multi-sensor radiation dosimeter of claim 1 wherein said accurate sensor is a high accuracy self-indicating sensor.

11. The multi-sensor radiation dosimeter of claim 9 wherein said high accuracy self-indicating sensor has an accuracy which is at least 90%.

12. The multi-sensor radiation dosimeter of claim 1 further having a core layer sandwiched between two layers.

13. The multi-sensor radiation dosimeter of claim 12 wherein said core layer has at least one cavity with at least one of said self indicating sensor and said accurate sensor therein.

14. A process for making a multi-sensor radiation dosimeter of claim 13 comprising forming said at least one cavity by cutting said core layer.

15. A process for making a multi-sensor radiation dosimeter of claim 13 comprising molding said core layer with at least one cavity.

16. The multi-sensor radiation dosimeter of claim 13 wherein said self indicating sensor and said accurate sensor are in said cavity.

17. The multi-sensor radiation dosimeter of claim 1 further comprising a protective layer.

18. The multi-sensor radiation dosimeter of claim 17 wherein said protective layer is selected from PET, PVC, PETG and UV absorbing PET.

19. The multi-sensor radiation dosimeter of claim 1 having at least one indicator for determining false positive or false negative signals.

20. The multi-sensor radiation dosimeter of claim 1 further comprising a temperature indicator.

21. The multi-sensor radiation dosimeter of claim 1 further comprising an indicator for exposure to UV and sunlight.

22. The multi-sensor radiation dosimeter of claim 1 further comprising a shelf life monitor.

23. The multi-sensor radiation dosimeter of claim 1 further comprising at least one indicator selected from a false positive indicator, a false negative indicator, a temperature indicator, a tampering indicator and a shelf life monitor.

24. The multi-sensor radiation dosimeter of claim 1 wherein said accurate sensor is sandwiched between two non-stick layers.

25. The multi-sensor radiation dosimeter of claim 24 wherein said non-stick layer is selected from Teflon and silicone.

26. The multi-sensor radiation dosimeter of claim 1 wherein said accurate sensor is encapsulated.

27. The multi-sensor radiation dosimeter of claim 1 further comprising a bonding layer.

28. The multi-sensor radiation dosimeter of claim 27 wherein said adhesive is a pressure sensitive adhesive.

29. The multi-sensor radiation dosimeter of claim 1 wherein said self indicating sensor comprises at least one conjugated acetylene.

30. The multi-sensor radiation dosimeter of claim 29 wherein said conjugated acetylene is a diacetylene.

31. The multi-sensor radiation dosimeter of claim 30 wherein said diacetylene containing material comprises:
R′—C≡C—C≡C—R″,
wherein R′ and R″ are the same or different substituent groups.

32. The multi-sensor radiation dosimeter of claim 31 wherein R′ and R″ are independently selected from (CH₂)_{b}—H; (CH₂)_{b}OH; (CH₂)_{b}—OCONH—R1; (CH₂)_{b}—O—CO—R1; (CH₂)_{b}—O—R1; (CH₂)_{b}—COOH; (CH₂)_{b}—COOM; (CH₂)_{b}—NH₂; (CH₂)_{b}—CONHR1; (CH₂)_{b}—NHCOR1; (CH₂)_{b}—CO—O—R1; where b=1-10; R1 is an aliphatic or aromatic radical, and M is a cation or a mixture thereof.

33. The multi-sensor radiation dosimeter of claim 31 wherein said diacetylene is selected from 2,4-hexadiyne, 2,4-hexadiyn-1,6-diol, 3,5-octadiyn-1,8-diol, 4,6-decadiyn-1,10-diol, 5,7-dodecadiyn-1,12-diol; diacetylenic fatty acids, pentacosa-10,12-diynoic acid and tricosa-10,12-diynoic acid or a mixture thereof.

34. The multi-sensor radiation dosimeter of claim 31 wherein said diacetylene is selected from urethane derivatives comprising alkyl, aryl, benzyl, methoxy phenyl, alkyl acetoacetate, fluoro phenyl, alkyl phenyl, halo-phenyl, cyclohexyl, toyl and ethoxy phenyl of 2,4-hexadiyn-1,6-diol, 3,5-octadiyn-1,8-diol, 4,6-decadiyn-1,10-diol, and 5,7-dodecadiyn-1,12-diol or a mixture thereof.

35. The multi-sensor radiation dosimeter of claim 31 wherein said diacetylene is selected from derivatives of 2,4-hexadiyn-1,6-diol; R′CH₂—C≡C—C≡C—CH₂R′, wherein R′ is selected from —OCONH(CH₂)₅CH₃, —OCONH(CH₂)₄—CH₃, —OCONH(CH₂)₃CH₃,
—OCONHCH₂CH₃, —OCONHCH₃; R′″CH₂—C≡C—C≡C—CH₂R′″, wherein R′″ is selected from —OCO(CH₂)₃CH₃, —OCOCH₂CH₃, —OCOCH₃; and cocrystallized mixtures thereof.

36. The multi-sensor radiation dosimeter of claim 31 wherein said diacetylene is a derivative of one material selected from 3,5-octadiyn-1,8-urethane; 4,6-decadiyn-1,10-urethane and 5,7-dodecadiyn-1,12-urethane.

37. The multi-sensor radiation dosimeter of claim 31 wherein said R′ and R″ are independently selected from —OCONH(CH₂)₅CH₃; —OCONH(CH₂)₄—CH₃; —OCONH(CH₂)₃CH₃;
—OCONH(CH₂)₂ CH₃; —OCONHCH₂CH₃; and —OCONHCH₃.

38. The multi-sensor radiation dosimeter of claim 31 wherein said diacetylene is selected from methyl, ethyl, propyl and butyl urethane derivatives of 4,6-decadiyn-1,10-diol.

39. The multi-sensor radiation dosimeter of claim 1 wherein said self-indicating sensor changes color in relation to received dose.

40. The multi-sensor radiation dosimeter of claim 1 wherein said self-indicating sensor changes optical density at a radiation dose of 0.1 to 1,000 rads.

41. The multi-sensor radiation dosimeter of claim 1 wherein said self-indicating sensor further comprises a shelf life extender.

42. The multi-sensor radiation dosimeter of claim 1 wherein said self-indicating sensor further comprises at least one stabilizer selected from the group consisting of heat stabilizer, reactive species quencher, radical scavenger, oxygen scavenger, antioxidant, reactive species inhibitor, reactive species preventor, thermo-oxidative preventor, photo-oxidative preventor, hydroperoxide decomposer, hydrogen donor, metal destabilizer, UB stabilizer, UB absorber, UV reflector, fluorescent and optical brightener.

43. The multi-sensor radiation dosimeter of claim 1 wherein at least one of said self-indicating sensor and said accurate sensor has a dose range of 0.01 rad to 1 megarad.

44. The multi-sensor radiation dosimeter of claim 1 further comprising at least one layer covering at least a portion of said dosimeter.

45. The multi-sensor radiation dosimeter of claim 44 wherein said layer covers said dosimeter.

46. The multi-sensor radiation dosimeter of claim 44 wherein said layer is at least one of removable and liftable.

47. A process for monitoring radiation comprising exposing a multi-sensor radiation dosimeter of claim 44, incidenting a light on said dosimeter and determining dose by monitoring emitted or absorbed light with a detector.

48. The process for monitoring radiation comprising exposing a multi-sensor radiation dosimeter of claim 47 wherein said detector is selected from the group consisting of a photo-detector and a CCD camera.

49. A process for monitoring radiation comprising:
providing a multi-sensor radiation dosimeter of claim 1;
exposing said multi-sensor radiation dosimeter to radiation causing at least one measurable signal on said multi-sensor radiation dosimeter wherein said measurable signal is correlated to said radiation; and
measuring said measurable signal.

50. The process for monitoring radiation of claim 49 further comprising removing said accurate sensor from said multi-sensor radiation dosimeter.

51. The process for monitoring radiation of claim 50 wherein said removing is by die cutting.

52. The process for monitoring radiation of claim 51 wherein said removing is by laser cutting.

53. A process for making a multi-sensor radiation dosimeter of claim 1 comprising lamination of a layer.

54. A process for detecting radiation comprising:
attaching a multi-sensor dosimeter comprising at least one self-indicating sensor and at least one an accurate sensor to an object;
exposing said multi-sensor dosimeter to radiation;
estimating dose immediately by reading said self-indicating sensor; and
determining dose by reading said accurate sensor.

55. The process of detecting radiation of claim 54 wherein said determining dose by said accurate sensor comprises a sensor selected from TLD, OSL, RLG, X-ray film and an electronic detector.

56. The process of detecting radiation of claim 54 further comprising archiving said dose.

57. The process of detecting radiation of claim 54 wherein said self indicating sensor comprises at least one conjugated acetylene.

58. The process of detecting radiation of claim 57 wherein said conjugated acetylene is a diacetylene.

59. The process of detecting radiation of claim 58 wherein said diacetylene comprises:
R′—C≡C—C≡C—R″,
wherein R′ and R″ are the same or different substituent groups.

60. The process of detecting radiation of claim 59 wherein R′ and R″ are independently selected from (CH₂)_{b}—H; (CH₂)_{b}OH; (CH₂)_{b}—OCONH—R1; (CH₂)_{b}—O—CO—R1; (CH₂)_{b}—O—R1; (CH₂)_{b}—COOH; (CH₂)_{b}—COOM; (CH₂)_{b}—NH₂; (CH₂)_{b}—CONHR1; (CH₂)_{b}—CO—O—R1; where b=1-10; R1 is an aliphatic or aromatic radical, and M is a cation.

61. The process of detecting radiation of claim 59 wherein said diacetylene is selected from 2,4-hexadiyne, 2,4-hexadiyn-1,6-diol, 3,5-octadiyn-1,8-diol, 4,6-decadiyn-1,10-diol, 5,7-dodecadiyn-1,12-diol and diacetylenic fatty acids, pentacosa-10,12-diynoic acid.

62. The process of detecting radiation of claim 59 wherein said diacetylene is selected from urethane derivatives comprising alkyl, aryl, benzyl, methoxy phenyl, alkyl acetoacetate, fluoro phenyl, alkyl phenyl, halo-phenyl, cyclohexyl, toyl and ethoxy phenyl of 2,4-hexadiyn-1,6-diol, 3,5-octadiyn-1,8-diol, 4,6-decadiyn-1,10-diol, and 5,7-dodecadiyn-1,12-diol.

63. The process of detecting radiation of claim 59 wherein said diacetylene is selected from derivatives of 2,4-hexadiyn-1,6-diol; R′CH₂—C≡C—C≡C—CH₂R′, wherein R′ is selected from —OCONH(CH₂)₅CH₃, —OCONH(CH₂)₄CH₃, —OCONH(CH₂)₃CH₃,
—OCONHCH₂CH₃, —OCONHCH₃; R′″CH₂—C≡C—C≡C—CH₂R′″, wherein R′″ is selected from —OCO(CH₂)₃CH₃, —OCOCH₂CH₃, —OCOCH₃; and cocrystallized mixtures thereof.

64. The process of detecting radiation of claim 59 wherein said diacetylene is a derivative of one material selected from 3,5-octadiyn-1,8-urethane; 4,6-decadiyn-1,10-urethane and 5,7-dodecadiyn-1,12-urethane.

65. The process of detecting radiation of claim 59 wherein said R′ and R″ are independently selected from —OCONH(CH₂)₅CH₃; —OCONH(CH₂)₄CH₃; —OCONH(CH₂)₃CH₃; —OCONH(CH₂)₂CH₃; —OCONHCH₂CH₃; and —OCONHCH₃.

66. The process of detecting radiation of claim 59 wherein said diacetylene is selected from methyl, ethyl, propyl and butyl urethane derivatives of 4,6-decadiyn-1,10-diol.

67. The process of detecting radiation of claim 54 wherein said self-indicating sensor changes color in relation to received dose.

68. The process of detecting radiation of claim 54 wherein said self-indicating sensor changes optical density at a radiation dose of 0.1 to 1,000 rads.

69. The process of detecting radiation of claim 54 wherein said self-indicating sensor further comprises a shelf life extender.

70. The process for detecting radiation of claim 54 wherein said object is a human being.

71. The process of detecting radiation of claim 54 wherein said self-indicating sensor further comprises at least one stabilizer selected from the group consisting of heat stabilizer, reactive species quencher, radical scavenger, oxygen scavenger, antioxidant, reactive species inhibitor, reactive species preventor, thermo-oxidative preventor, photo-oxidative preventor, hydroperoxide decomposer, hydrogen donor, metal destabilizer, UB stabilizer, UB absorber, UV reflector, fluorescent and optical brightener.

72. A multi-sensor radiation dosimeter having at least one self-indicating sensor and at least one accurate sensor sandwiched between two layers wherein one layer of said two layers is transparent.
